(19) United States
(12) Patent Application Publication
(10) Pub. No.: US 2018/0222430 A1
(43) Pub. Date: Aug. 9, 2018

(54) VEHICLE AIR BAG DOOR

(71) Applicants: TOYODA GOSEI CO., LTD., Kiyosu-shi, Aichi-ken (JP); TOYOTA JIDOSHA KABUSHIKI KAISHA, Toyota-shi, Aichi-ken (JP)

(72) Inventors: Chiharu TOTANI, Kiyosu-shi, Aichi-ken (JP); Koichi SUZUKI, Kiyosu-shi, Aichi-ken (JP); Shunta ASAKUMA, Kiyosu-shi, Aichi-ken (JP); Masahito YABUOSHI, Chiryu-shi, Aichi-ken (JP)

(21) Appl. No.: 15/749,138

(22) PCT Filed: Jul. 26, 2016
(86) PCT No.: PCT/JP2016/071828

§ 371 Date: Jan. 31, 2018

(30) Foreign Application Priority Data
Sep. 9, 2015 (JP) 2015-177855

(51) Int. Cl. B60R 21/2165; B32B 3/26; B32B 5/02; B32B 5/26; B32B 5/06; B32B 27/12; B32B 27/32

(52) U.S. Cl. CPC B60R 21/2165; B32B 3/266; B32B 5/026; B60R 21/205; B32B 5/06; B32B 27/12; B32B 27/32; B32B 5/26

(57) ABSTRACT

An automobile airbag door includes a base member and a cover member. A tear line TL is formed in the back of the base member. When the airbag door is pressed by the airbag, the tear line TL provides a starting point of tearing action. The cover member includes a three-dimensionally knitted cushion layer, which includes a top-side knitted fabric layer, a back-side knitted fabric layer, and a connection layer. The connection layer is configured by connecting yarn, which couples the top-side knitted fabric layer and the back-side knitted fabric layer to each other. The weight per unit length of the connecting yarn is greater than the weight per unit length of the yarn constituting the top-side knitted fabric layer and is greater than the weight per unit length of the yarn constituting the back-side knitted fabric layer.

### CROSS REFERENCE TO RELATED APPLICATIONS

This application is a U.S. national stage application of International Application No. PCT/JP2016/071828, filed on Jul. 26, 2016, which claims priority to Japanese Patent Application No. 2015-177855 filed on Sep. 9, 2015, the contents of which are incorporated herein by reference.

### BACKGROUND

The present invention relates to an automobile airbag door that is opened when torn by pressing force of an airbag being deployed and inflated.

Conventionally, an automobile is equipped with a front passenger seat airbag apparatus as a means for protecting the occupant on the front passenger seat (for example, refer to Patent Document 1). In the front passenger seat airbag apparatus, a part of the instrument panel arranged in front of the front passenger seat of the automobile forms an airbag door. The airbag door includes a base member, which serves as a core member, and a cover member bonded to the surface of the base member. The cover member includes a cushion layer bonded to the surface of the base member and a covering bonded to the surface of the cushion layer.

Some airbag doors have a three-dimensionally knitted cushion layer, which is, for example, configured by double-raschel knitted fabric, to give elasticity to the airbag door, thereby improving the tactile sensation.

The airbag door has a tear line (a tearable line), which is formed by a plurality of short cleavage grooves or a single elongated cleavage groove and functions as the starting point of tearing leading to an opening action. The tear line allows the airbag door to be smoothly opened and the airbag to be smoothly deployed and inflated. To be inconspicuous from the surface side of the airbag door, the tear line is formed on the back side of the airbag door. For example, the tear line is formed in the base member and the cushion layer. In addition to the tear lines formed in the base member and the cushion layer, some airbag doors are also provided with a tear line formed in the back side of the covering. This allows the tear line to be invisible from the side of the ornamental surface.

When an impact is applied from the front to an automobile equipped with the above described front passenger seat airbag apparatus, for example, due to a frontal collision, the inflator supplies inflation gas to the airbag to deploy and inflate the airbag. The airbag, in turn, presses the airbag door, thereby tearing the base member and the cover member along the tear lines to open the airbag door. The airbag passes through the opened airbag door to be deployed and inflated between the instrument panel and the occupant seated on the front passenger seat, thereby reducing the impact applied to the occupant from the front.

### Patent Document

Patent Document 1: Japanese National Phase Laid-Open Patent Publication No. 2005-537164

In conventional airbag doors, a tear line is formed at least in the cushion layer in the cover member to allow the cover member to be torn along the tear line in the base member. This requires a step for forming a tear line at least in the cushion layer. In addition, a step is required for bonding the cushion layer to the surface of the base member while positioning and aligning the tear line in the base member and the tear line in the cushion member with each other. This increases the number of steps and complicates the process.

In the case where a three-dimensionally knitted cushion layer is used, the rupture strength of the three-dimensionally knitted cushion layer can be reduced by thinning the yarn so that it is easily cut, thereby omitting the step for forming a tear line. However, in this case, thinning of the yarn impairs the cushioning property, that is, the tactile sensation of the three-dimensionally knitted cushion layer.

### SUMMARY

Accordingly, it is an objective of the present invention to provide an automobile airbag door that allows the airbag to be deployed in a favorable manner while improving the tactile sensation without performing a step for forming a tear line in the cushion layer.

To achieve the foregoing objective, an automobile airbag door is provided that includes a base member and a cover member, which is bonded to a surface of the base member. A tear line is formed in a back of the base member. When the airbag door is pressed by the airbag being deployed and inflated, the tear line provides a starting point of tearing action. The cover member includes a three-dimensionally knitted cushion layer. The three-dimensionally knitted cushion layer includes a top-side knitted fabric layer, a back-side knitted fabric layer, which is bonded to the surface of the base member, and a connection layer, which is configured by connecting yarn connecting the top-side knitted fabric layer and the back-side knitted fabric layer to each other. A weight per unit length of the connecting yarn is greater than a weight per unit length of yarn constituting at least one of the top-side knitted fabric layer and the back-side knitted fabric layer.

With this configuration, the weight per unit length of the connecting yarn, which constitutes the connection layer, is greater than the weight per unit length of the yarn constituting at least one of the top-side knitted fabric layer and the back-side knitted fabric layer. Thus, the connection layer improves the cushioning property of the whole three-dimensionally knitted cushion layer. Also, at least one of the top-side knitted fabric layer and the back-side knitted fabric layer is formed by yarn that is more easily broken than the connecting yarn, so that the rupture strength of at least one of the top-side knitted fabric layer and the back-side knitted fabric layer is reduced. This reduces the rupture strength of the whole three-dimensionally knitted cushion layer. This configuration allows the airbag to be deployed in a favorable manner while improving the tactile sensation without performing a step for forming a tear line in the cushion layer.

In the above-described automobile airbag door, the weight per unit length of the connecting yarn is preferably greater than the weight per unit length of the yarn constituting the top-side knitted fabric layer and is preferably greater than the weight per unit length of the yarn constituting the back-side knitted fabric layer.

With this configuration, both the top-side knitted fabric layer and the back-side knitted fabric layer are configured by yarn that is more easily broken than the connecting yarn, which constitutes the connection layer. This reduces the rupture strength of the top-side knitted fabric layer and the back-side knitted fabric layer, so that the rupture strength of the whole three-dimensionally knitted cushion layer is further reduced. This configuration allows the airbag to be deployed in a more favorable manner while improving the tactile sensation without performing a step for forming a tear line in the cushion layer.

In the above-described automobile airbag door, the weight per unit length of the connecting yarn is preferably in a range from 30 to 400 decitex.

This configuration improves the tactile sensation of the airbag door.

The present invention allows an airbag to be deployed in a favorable manner while improving the tactile sensation without performing a step for forming a tear line in the cushion layer.

### BRIEF DESCRIPTION OF THE DRAWINGS

FIG. 1 is a diagram of an automobile airbag door according to one embodiment, showing a perspective view of an instrument panel in which a front passenger seat airbag apparatus is mounted.

FIG. 2 is a schematic plan view showing the front passenger seat airbag apparatus of FIG. 1, illustrating a state in which the airbag is deployed and inflated to protect the occupant on the front passenger seat.

FIG. 3 is a partial plan view of the airbag door and its surroundings in the instrument panel of FIG. 2.

FIG. 4 is a partially cross-sectional view taken along line 4-4 of FIG. 3, illustrating the airbag apparatus.

FIG. 5 is a partial cross-sectional view of section X of FIG. 4.

FIG. 6 is a diagram showing the anisotropy in the tensile strength of the three-dimensionally knitted cushion layer of FIG. 5.

FIG. 7 is a diagram showing the anisotropy in the tensile strength of the ground fabric layer of FIG. 5.

FIG. 8 is a partial plan view of the back of the base member of FIG. 5, showing a part in which a tear line is formed.

FIG. 9 is a partial plan view of the surface of the three-dimensionally knitted cushion layer of FIG. 5, showing a part corresponding to the part in which the tear line is formed.

### DETAILED DESCRIPTION

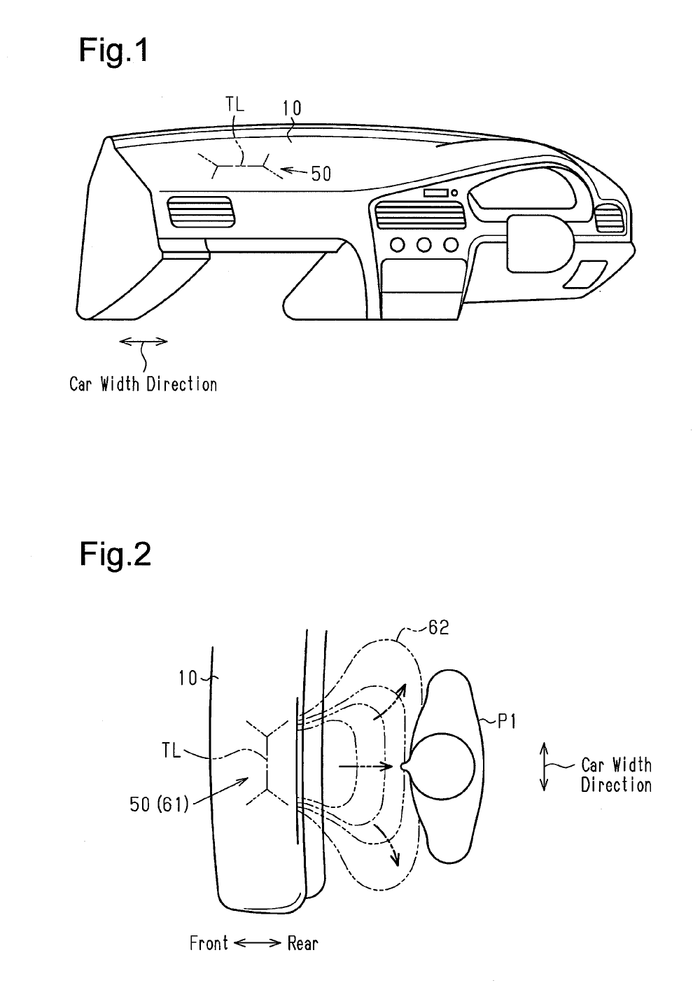

One embodiment will now be described with reference to FIGS. 1 to 9. In the following description, the advancing direction of the automobile is defined as a forward direction. The rearward, upward, downward, leftward, and rightward directions are defined with reference to the forward direction. Thus, the left-right direction agrees with the width direction of the automobile (car width direction).

As shown in FIGS. 1 and 2, an automobile includes an instrument panel 10, which extends along the width of the automobile and is arranged forward of the driver's seat and the front passenger seat.

As shown in FIG. 2, the automobile has a front passenger seat airbag apparatus (hereinafter, referred to as an airbag apparatus 61), which deploys and inflates an airbag 62 in front of an occupant P1 seated on the front passenger seat to protect the occupant P1 from an impact applied from the front.

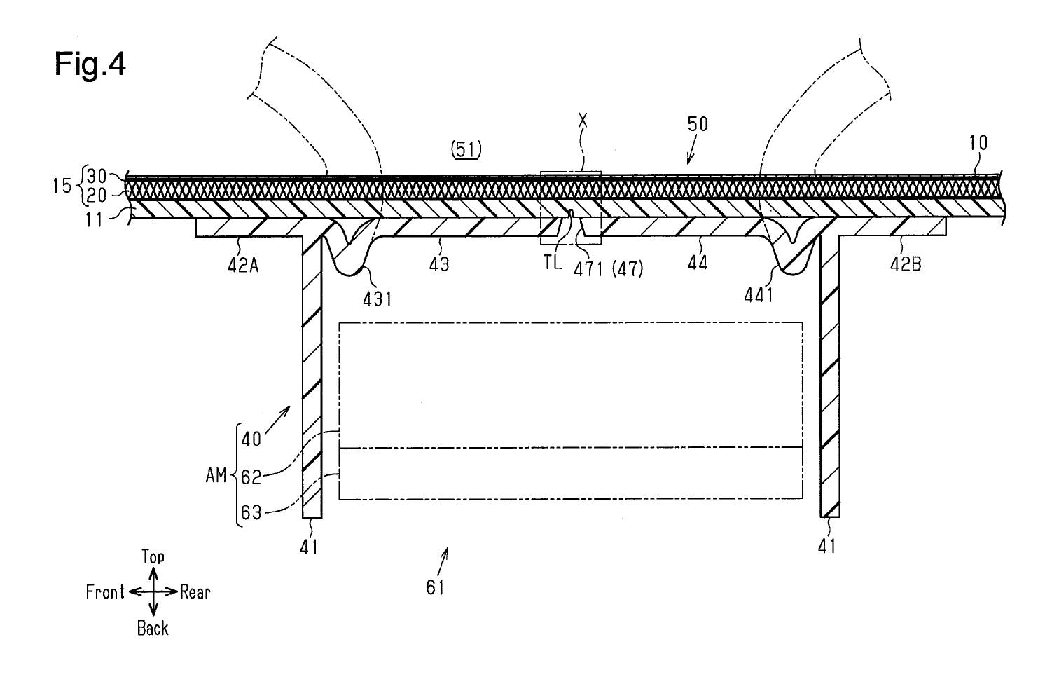

As shown in FIG. 4, the airbag apparatus 61 has an automobile airbag door (hereinafter, referred to as an airbag door 50), which is formed in a part of the instrument panel 10 in front of the front passenger seat, and an airbag module AM, which is located on the back side of the airbag door 50. When the airbag apparatus 61 is activated, the airbag door 50 is pressed by the airbag 62 being deployed and inflated and is opened toward the front passenger seat, thereby defining an opening 51, which allows the airbag 62 to be deployed.

### <Regarding Basic Structure of Airbag Door 50>

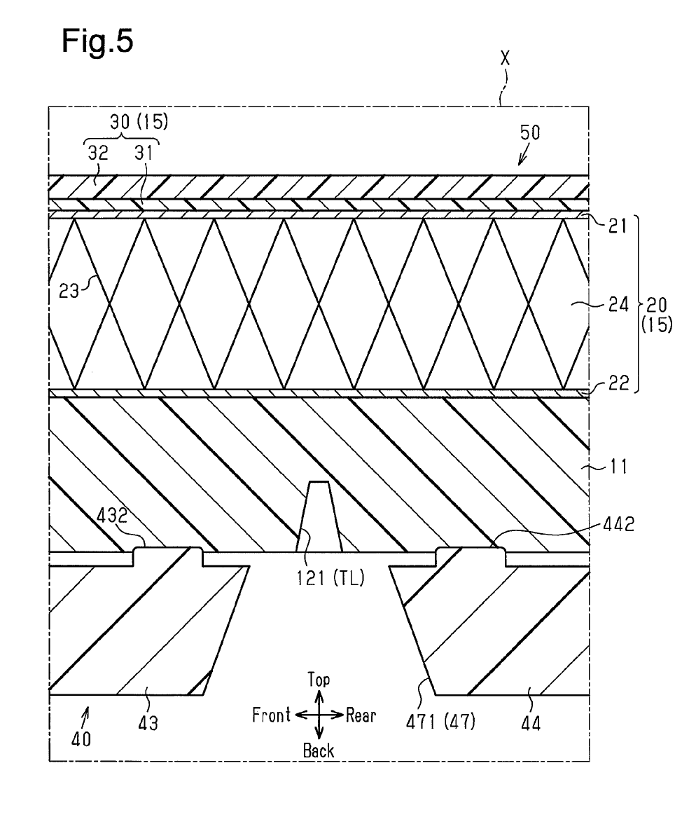

As shown in FIGS. 4 and 5, the airbag door 50 includes a base member 11, which is a core member, and a cover member 15.

The base member 11 is made of a plastic such as thermoplastic olefin (TPO) or polypropylene by injection molding. The base member 11, for example, has a thickness of 2.5 to 3.5 mm.

As shown in FIG. 5, the cover member 15 includes a three-dimensionally knitted cushion layer 20, which is bonded to the surface of the base member 11 with adhesive, and a covering 30 bonded to the surface of the three-dimensionally knitted cushion layer 20.

The three-dimensionally knitted cushion layer 20 is used to give a required cushioning property (elasticity) to the airbag door 50, thereby improving the tactile sensation. The three-dimensionally knitted cushion layer 20 is configured by a double-raschel knitted fabric and is bonded to the surface of the base member 11.

The three-dimensionally knitted cushion layer 20 includes a top-side knitted fabric layer 21, a back-side knitted fabric layer 22, and a connection layer 24, and is formed by a double-raschel machine.

The top-side knitted fabric layer 21 is constructed by twine, which is formed by threads of a single type, and forms a planar and regularly arranged mesh pattern.

The back-side knitted fabric layer 22 is constructed by twine, which is formed by threads of a single type, and forms a planar and regularly arranged mesh pattern.

The top-side knitted fabric layer 21 and the back-side knitted fabric layer 22 are configured by yarn of synthetic fiber such as polyester fiber, polyamide fiber, acrylic fiber, and polypropylene fiber.

The top-side knitted fabric layer 21 and the back-side knitted fabric layer 22 each have a flat fabric structure (for example, tricot knitting, cord knitting, and atlas knitting, which are three basic knit constructions of warp knitting). The knitted structures of the top-side knitted fabric layer 21 and the back-side knitted fabric layer 22 may be the same or different.

The connection layer 24 is formed of connecting yarn 23 that connects the top-side knitted fabric layer 21 and the back-side knitted fabric layer 22. The connecting yarn 23 is made of polytrimethylene terephthalate fiber, polyethylene terephthalate fiber, polybutylene terephthalate fiber, polyamide fiber, polyvinyl chloride fiber, or polyester-based elastomer fiber. In order to maintain a good long-lasting cushioning property after repetitive or long-time compressions of the three-dimensionally knitted cushion layer 20, it is preferable that polytrimethylene terephthalate fiber be used for at least a part of the connecting yarn 23. The cross-sectional shape of the fiber preferably has a round cross-sectional shape in view of maintaining a good cushioning property for a long time. Monofilament yarn is used for the connecting yarn 23 in view of reduction of the displacement force.

The connecting yarn 23 may form loop-shaped stitches in the knitted fabrics of the top-side knitted fabric layer 21 and the back-side knitted fabric layer 22. The connecting yarn 23 may be hooked to both knitted fabric layers 21 and 22 by being inserted thereinto or by tuck stitches. In particular, it is preferable that at least two connecting yarn 23 be inclined obliquely in opposite directions to connect the knitted fabric layers 21 and 22 in a crossing (X-shaped) structure or a truss structure in view of improving the shape stability of the three-dimensionally knitted cushion layer 20 and providing a favorable cushioning property. A truss structure is a structural form constituted by an aggregation of triangular basic units. Substantially triangular shapes are formed by the connecting yarn 23 and the top-side knitted fabric layer 21, or by the connecting yarn 23 and the back-side knitted fabric layer 22. In this case, the connecting yarn 23 may be constituted by two threads in a crossing structure or a truss structure. Further, the connecting yarn 23 may be constituted by a single thread, and the connecting yarn 23 may be folded back at the top-side knitted fabric layer 21 and the back-side knitted fabric layer 22, resulting in a seemingly two-thread structure.

Having no layered structure, the above described three-dimensionally knitted cushion layer 20 is excellent in breathability and cushioning property, for example. The thickness of the three-dimensionally knitted cushion layer 20 may be changed by adjusting the lengths of the connecting yarn 23. In the present embodiment, the three-dimensionally knitted cushion layer 20 is formed to have a thickness of 2.5 mm or more.

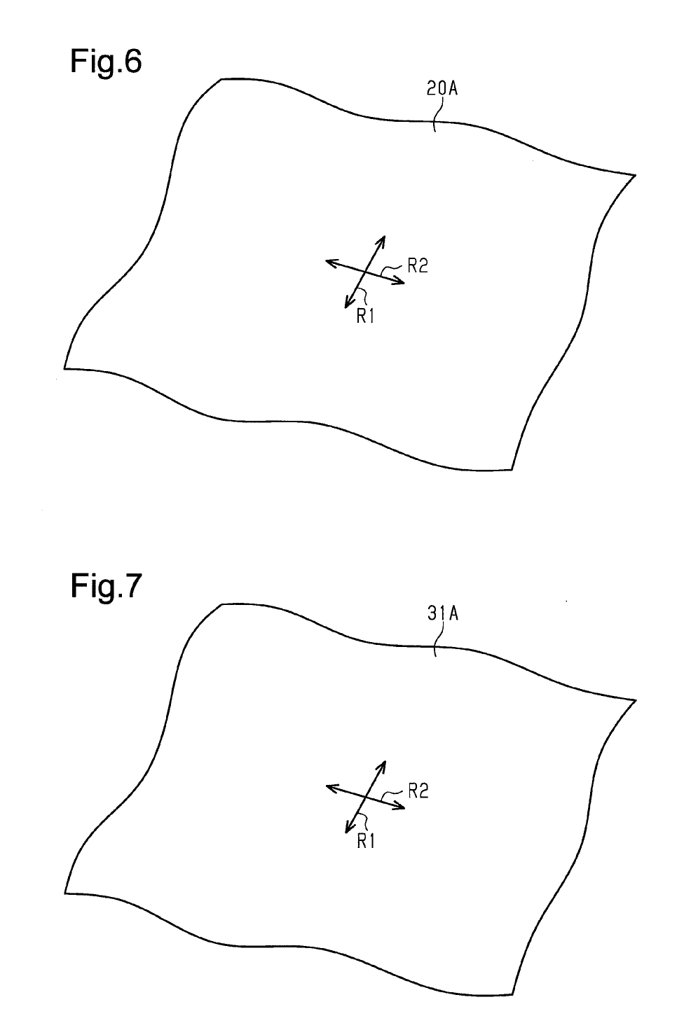

As shown in FIG. 6, an original fabric 20A of the three-dimensionally knitted cushion layer 20 has anisotropy in the tensile strength in directions along the surface. That is, the tensile strength of the original fabric 20A is set to be the smallest in a first direction R1 along the surface and is set to be the greatest in a second direction R2, which is perpendicular to the direction R1.

The layer between the base member 11 and the covering 30 (the cushion layer) is constituted by the three-dimensionally knitted cushion layer 20 for the following reasons. That is, compared to a cushion layer made of woven fabric, the three-dimensionally knitted cushion layer 20 improves the stretchability and flexibility of itself and those of the covering 30. Compared to a cushion layer formed of urethane foam, the three-dimensionally knitted cushion layer 20 improves the cushioning property and the tactile sensation of the airbag door 50. Further, if the three-dimensionally knitted cushion layer 20 is formed by an original fabric made of warp knitting, the fabric is stabilized.

As shown in FIG. 5, the covering 30 is provided to improve the texture and tactile sensation of the airbag door 50 and is made of artificial leather in the present embodiment. The artificial leather is constituted by a ground fabric layer 31 and a covering layer 32 bonded to the surface of the ground fabric layer 31. That is, the artificial leather has a two-layer structure.

The ground fabric layer 31 is formed by processing a cloth of knitted fabric or woven fabric of synthetic resin fiber such as polyester fiber and polyamide fiber.

As shown in FIG. 7, an original fabric 31A of the ground fabric layer 31 has anisotropy in the tensile strength in directions along the surface. The tensile strength of the original fabric 31A is set to be the smallest in a first direction R1 along the surface and is set to be the greatest in a second direction R2, which is perpendicular to the direction R1.

As shown in FIG. 5, the covering layer 32 constitutes the outer surface (ornamental surface) of the airbag door 50 and is made of, for example, polyurethane. The covering layer 32 is bonded to the ground fabric layer 31.

The covering 30 (the ground fabric layer 31 and the covering layer 32) preferably has a thickness in the range from 0.3 mm to 1.0 mm. If the thickness were less than 0.3 mm, it would be difficult to ensure a sufficient strength when the covering 30 is bonded to the surface of the three-dimensionally knitted cushion layer 20. If the thickness were greater than 1.0 mm, it would be difficult to allow the covering 30 to be torn in a favorable manner. The covering 30 more preferably has a thickness in the range from 0.4 mm to 0.7 mm.

If the thickness of the covering 30 is set to be in the above-described range, the tearing load of the covering 30 will be less than that in the conventional structures.

The ground fabric layer 31 and the three-dimensionally knitted cushion layer 20 are bonded to each other with the first direction R1 (FIG. 7), in which the tensile strength of the ground fabric layer 31 is smallest, aligned with the first direction R1 (FIG. 6), in which the tensile strength of the three-dimensionally knitted cushion layer 20 is smallest. Thus, the tensile strengths of the ground fabric layer 31 and the three-dimensionally knitted cushion layer 20 are smallest in the first direction R1.

<Regarding General Structure of Airbag Module AM>

As shown in FIG. 4, a retainer 40 is provided on the back side of the airbag door 50. The retainer 40 has front and rear wall portions 41, which are arranged in the front-rear direction to face each other with a space in between, and left and right wall portions (not shown), which are arranged in the car width direction to face each other with a space in between. The front and rear wall portions 41 hold the airbag 62 in a folded state and an inflator 63, which generates and supplies inflation gas to the airbag 62. The retainer 40, the airbag 62, and the inflator 63 constitute the airbag module AM.

As shown in FIG. 4, a first extended portion 42A, which extends forward along the back of the airbag door 50, and a front-side door portion 43, which extends rearward via a first hinge portion 431, are coupled to the top-side end of the front wall portion 41. A second extended portion 42B, which extends rearward along the back of the airbag door 50, and a rear-side door portion 44, which extends forward via a second hinge portion 441, are coupled to the top-side end of the rear wall portion 44.

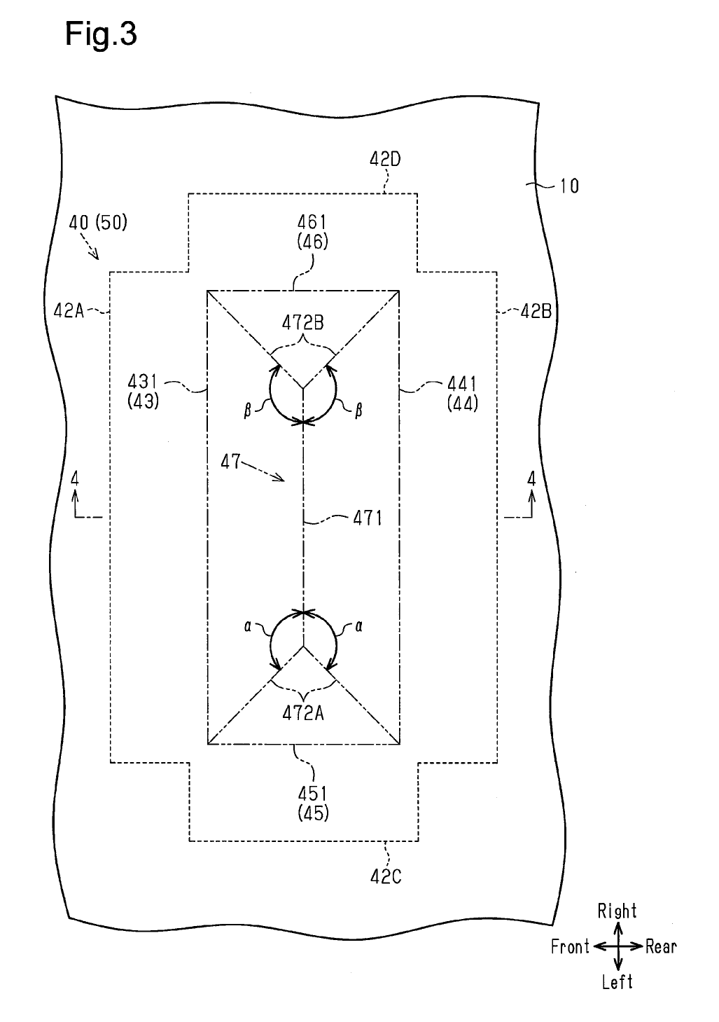

As shown in FIGS. 3 and 4, a first groove 471 of a through-groove 47, which extends in the car width direction, is located between the front-side door portion 43 and the rear-side door portion 44.

As shown in FIG. 3, a third extended portion 42C, which extends leftward along the back of the airbag door 50, and a left-side door portion 45, which extends rightward via a third hinge portion 451, are coupled to the top-side end of the left wall portion (not shown) of the retainer 40. A fourth extended portion 42D, which extends rightward along the back of the airbag door 50, and a right-side door portion 46, which extends leftward via a fourth hinge portion 461, are coupled to the top-side end of the right wall portion (not shown) of the retainer 40.

A pair of V-shaped second grooves 472A is formed on the left end of the first groove 471 in the car width direction. A pair of V-shaped third grooves 472B is formed on the right end of the first groove 471 in the car width direction. The second grooves 472A and the third grooves 472B are through-grooves. The second grooves 472A and the third grooves 472B extend outward in the car width direction from the opposite ends of the first groove 471 in a spreading manner in the front-rear direction. The front one of the two second grooves 472A is located at the boundary between the front-side door portion 43 and the left-side door portion 45. The rear one of the two second grooves 472A is located at the boundary between the rear-side door portion 44 and the left-side door portion 45. The front one of the two third grooves 472B is located at the boundary between the front-side door portion 43 and the right-side door portion 46. The rear one of the two third grooves 472B is located at the boundary between the rear-side door portion 44 and the right-side door portion 46.

The angle α defined by the first groove 471 and each second groove 472A is set to an obtuse angle. The angle R defined by the first groove 471 and each third groove 472B is set to an obtuse angle. Such settings of angles are employed to utilize the force by which a first cleavage groove 121 is torn from the center in the car width direction toward the outer sides in a favorable manner, so that second and third cleavage grooves 122A, 122B are smoothly torn. The cleavage grooves 121, 122A, 122B will be discussed below. In the present embodiment, the angles α and β are all set to 135 degrees.

The retainer 40, which has the above-described configuration, is made of, for example, thermoplastic olefin (TPO) by injection molding. As shown in FIG. 5, a plurality of protrusions 432 are formed on the surface of the front-side door portion 43, and a plurality of protrusions 442 are formed on the surface of the rear-side door portion 44. FIG. 5 illustrates one of the protrusions 432 and one of the protrusions 442. Protrusions (not shown) similar to those on the front-side door portion 43 and the rear-side door portion 44 are formed on the surfaces of the first to fourth extended portions 42A, 42B, 42C, 42D, the left-side door portion 45, and the right-side door portion 46. The protrusions 432, 442 are fixed to the back of the base member 11 of the airbag door 50, for example, by vibration-welding.

<Regarding Tear Line TL>

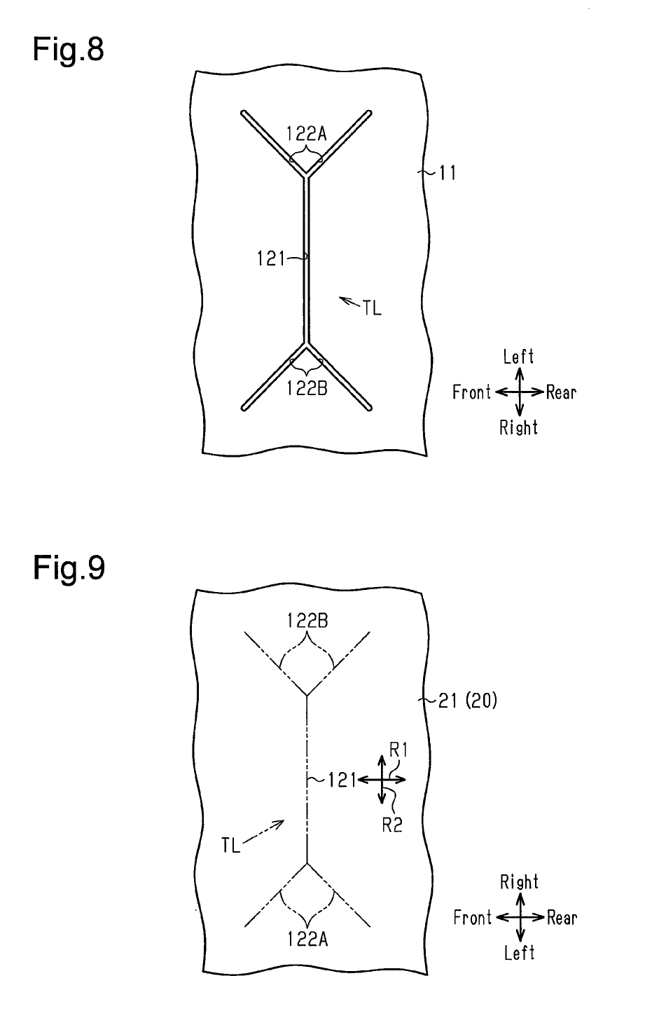

As shown in FIGS. 4, 5, and 8, a tear line TL is formed in the back of the base member 11. As shown in FIG. 8, the tear line TL is formed by a first cleavage groove 121, which extends in the car width direction, a pair of second cleavage grooves 122A, which extends from the left end of the first cleavage groove 121, a pair of third cleavage grooves 122B, which extends from the right end of the first cleavage groove 121. The tear line TL is located on the top side of the through-groove 47 of the retainer 40. The second cleavage grooves 122A form a V-shape and include a section that extends outward in the car width direction and diagonally forward and a section that extends outward in the car width direction and diagonally rearward. The third cleavage grooves 122B form a V-shape and include a section that extends outward in the car width direction and diagonally forward and a section that extends outward in the car width direction and diagonally rearward. Thus, the parts of the base member 11 where the first cleavage groove 121, the second cleavage grooves 122A, and the third cleavage grooves 122B are formed are thinner than the remaining parts and have a lower strength. As shown in FIG. 5, the first cleavage groove 121 has a trapezoidal cross-sectional shape with the width decreasing toward the top side. In the present embodiment, the width of the first cleavage groove 121 on the top side is set to 1.0 mm. The second cleavage grooves 122A and the third cleavage grooves 122B each have a similar cross-sectional shape as that of the first cleavage groove 121.

In contrast, the cover member 15 of the present embodiment (the three-dimensionally knitted cushion layer 20, the ground fabric layer 31, and the covering layer 32) has no cleavage grooves.

As shown in FIGS. 8 and 9, the tear line TL is configured such that the first cleavage groove 121 extends in the direction R2, in which the tensile strength of the three-dimensionally knitted cushion layer 20 is the greatest.

To open the airbag door 50, the tear line TL is pressed by the airbag 62 being deployed and inflated to provide the starting point of tearing action of the airbag door 50. The tear line TL is provided for smoothly opening the airbag door 50 and ensuring smooth deployment and inflation of the airbag 62.

In the present embodiment, the tear line TL is configured such that, when the airbag door 50 is pressed by the airbag 62 being deployed and inflated, the first cleavage groove 121 is torn prior to the second cleavage grooves 122A and the third cleavage grooves 122B.

Characteristic features of the present embodiment will now be described.

The twine that constitutes the top-side knitted fabric layer 21 and the back-side knitted fabric layer 22 is formed by twisting together twenty-four threads, and the weight per unit length of the twine is 22 decitex (dtex). In contrast, the connecting yarn 23 is formed by a single thread, and its weight per unit length is 33 decitex (dtex). The decitex (dtex) is a unit indicating the weight of yarn per unit length and represents the number of grams of yarn per 10,000 m.

It is preferable to set the weight per unit length of the connecting yarn 23 to 30 to 400 decitex (dtex) in order to improve the tactile sensation of the airbag door 50. It is preferable to set the weight per unit length of the yarn constituting the top-side knitted fabric layer 21 to be not more than 200 decitex (dtex) in order to lower the rupture strength of the top-side knitted fabric layer 21. It is preferable to set the weight per unit length of the yarn constituting the back-side knitted fabric layer 22 to be in the range from 20 to 200 decitex (dtex) in order to lower the rupture strength of the back-side knitted fabric layer 22.

The operation of the present embodiment will now be described.

The weight per unit length of the connecting yarn 23, which constitutes the connection layer 24, is greater than the weight per unit length of the yarn constituting the top-side knitted fabric layer 21 and is greater than the weight per unit length of the yarn constituting the back-side knitted fabric layer 22. Thus, the cushioning property of the three-dimensionally knitted cushion layer 20 as a whole is ensured by the connection layer 24. Both the top-side knitted fabric layer 21 and the back-side knitted fabric layer 22 are formed by yarn that is more easily broken than the connecting yarn 23, which constitutes the connection layer 24, so as to reduce the rupture strength of both the top-side knitted fabric layer 21 and the back-side knitted fabric layer 22. This reduces the rupture strength of the three-dimensionally knitted cushion layer 20 as a whole.

The automobile airbag door according to the above-described embodiment has the following advantage.

(1) The weight per unit length of the connecting yarn 23, which constitutes the connection layer 24 of the three-dimensionally knitted cushion layer 20, is greater than the weight per unit length of the yarn constituting the top-side knitted fabric layer 21 and is greater than the weight per unit length of the yarn constituting the back-side knitted fabric layer 22. Such a configuration allows the airbag 62 to be deployed in a favorable manner while improving the tactile sensation without performing a step for forming a tear line in the three-dimensionally knitted cushion layer 20.

<Modifications>

The above-described embodiment may be modified as follows.

The three-dimensionally knitted cushion layer 20 does not necessarily have anisotropy in the tensile strength in directions along its surface.

The ground fabric layer 31 does not necessarily have anisotropy in the tensile strength in directions along its surface.

The ground fabric layer 31, which constitutes the covering 30, may be omitted so that the covering layer 32 is directly bonded to the surface of the three-dimensionally knitted cushion layer 20. In this case, if a three-dimensionally knitted cushion layer 20 having no anisotropy in the tensile strength in the directions along the surface is employed as in the above modification, the whole cover member 15 would have no anisotropy in the tensile strength in the directions along that surface.

For example, the weight per unit length of the connecting yarn 23 may be greater than the weight per unit length of the yarn constituting the back-side knitted fabric layer 22 and equal to that of the yarn constituting the top-side knitted fabric layer 21. Also, the weight per unit length of the connecting yarn 23 may be greater than the weight per unit length of the yarn constituting the top-side knitted fabric layer 21 and equal to that of the yarn constituting the back-side knitted fabric layer 22. In short, the weight per unit length of the yarn, which constitutes the connection layer 24, is greater than the weight per unit length of the yarn constituting at least one of the top-side knitted fabric layer 21 and the back-side knitted fabric layer 22.

1. An automobile airbag door comprising:
a base member; and
a cover member, which is bonded to a surface of the base member, wherein
a tear line is formed in a back of the base member,
when the airbag door is pressed by the airbag being deployed and inflated, the tear line provides a starting point of tearing action,
the cover member includes a three-dimensionally knitted cushion layer,
the three-dimensionally knitted cushion layer includes
a top-side knitted fabric layer,
a back-side knitted fabric layer, which is bonded to the surface of the base member, and
a connection layer, which is configured by connecting yarn connecting the top-side knitted fabric layer and the back-side knitted fabric layer to each other,
a weight per unit length of the connecting yarn is greater than a weight per unit length of yarn constituting at least one of the top-side knitted fabric layer and the back-side knitted fabric layer, and
a rupture strength of at least one of the top-side knitted fabric layer and the back-side knitted fabric layer is lower than that of the connection layer.

2. The automobile airbag door according to claim 1, wherein the weight per unit length of the connecting yarn is greater than the weight per unit length of the yarn constituting the top-side knitted fabric layer and is greater than the weight per unit length of the yarn constituting the back-side knitted fabric layer.

3. The automobile airbag door according to claim 1, wherein the weight per unit length of the connecting yarn is in a range from 30 to 400 decitex.

4. The automobile airbag door according to claim 1, wherein the connecting yarn is configured by monofilament yarn.
